(19) United States
(12) Patent Application Publication
(10) Pub. No.: US 2016/0364085 A1
(43) Pub. Date: Dec. 15, 2016

(54) INSTANT MESSAGING USER INTERFACE

(71) Applicant: Cisco Technology, Inc., San Jose, CA (US)

(72) Inventors: Andrew HENDERSON, Spiddal, Co. Galway (IE); Stewart CURRY, Booterstown, Co. Dublin (IE)

(21) Appl. No.: 14/738,999

(22) Filed: Jun. 15, 2015

(51) Int. Cl. G06F 3/0481; H04L 12/58; G06F 3/0486; G06F 7/14; G06F 3/0484; G06F 7/08

(52) U.S. Cl. CPC G06F 3/0481; G06F 3/04845; G06F 7/08; G06F 3/0486; G06F 7/14; H04L 51/04; G06F 2203/04803

(57) ABSTRACT

In one embodiment, a method implemented on a computing device, includes: rendering a user interface on a display screen of the computing device, the user interface comprising a plurality of bands arranged adjacently to each other in a single user interface window, wherein at least one of the plurality of bands represents a communication between a user of the computing device and one or more remote users; receiving input signals from a user of the computing device, the input signals corresponding to a user interacting with one of said plurality of bands of the user interface; and in response to the received input signals, rearranging the plurality of bands; and resizing the single user interface window to fit the rearranged plurality of bands.

### TECHNICAL FIELD

The present disclosure relates generally to data communications and user interfaces.

### BACKGROUND

Instant Messaging applications enable users to easily see whether a chosen person (e.g., a friend, colleague, co-worker or the like) is connected to the Internet and, if so, to exchange messages with him. Instant messaging applications typically enable text messaging, voice messaging and file sharing. Advances in communications technologies have challenged designers of user interfaces for instant messaging applications. For example, a common challenge has been to design and implement user interfaces that provide an appropriate balance of information, usability, intuitiveness, control, and functionality, thus promoting a quality user experience.

### BRIEF DESCRIPTION OF THE DRAWINGS

The present invention will be understood and appreciated more fully from the following detailed description, taken in conjunction with the drawings in which:

FIG. 1 is a simplified pictorial illustration of a user interface, constructed and operative in accordance with an embodiment of the present invention;

FIGS. 2A, 2B and 2C are simplified pictorial illustrations of user interfaces, constructed and operative in accordance with embodiments of the present invention;

FIGS. 3A, 3B, 3C, 3D and 3E are simplified pictorial illustrations showing interactions between columns of a user interface, constructed and operative in accordance with further embodiments of the present invention; and

FIG. 4 is a simplified flow chart diagram illustrating a method for operating the user interface in accordance with embodiments of the present invention.

### DESCRIPTION OF EXAMPLE EMBODIMENTS

### Overview

In one embodiment, a method implemented on a computing device, includes: rendering a user interface on a display screen of the computing device, the user interface comprising a plurality of bands arranged adjacently to each other in a single user interface window, wherein at least one of the plurality of bands represents a communication between a user of the computing device and one or more remote users; receiving input signals from a user of the computing device, the input signals corresponding to a user interacting with one of said plurality of bands of the user interface; and in response to the received input signals, rearranging the plurality of bands; and resizing the single user interface window to fit the rearranged plurality of bands.

### DETAILED DESCRIPTION OF EXAMPLE EMBODIMENTS

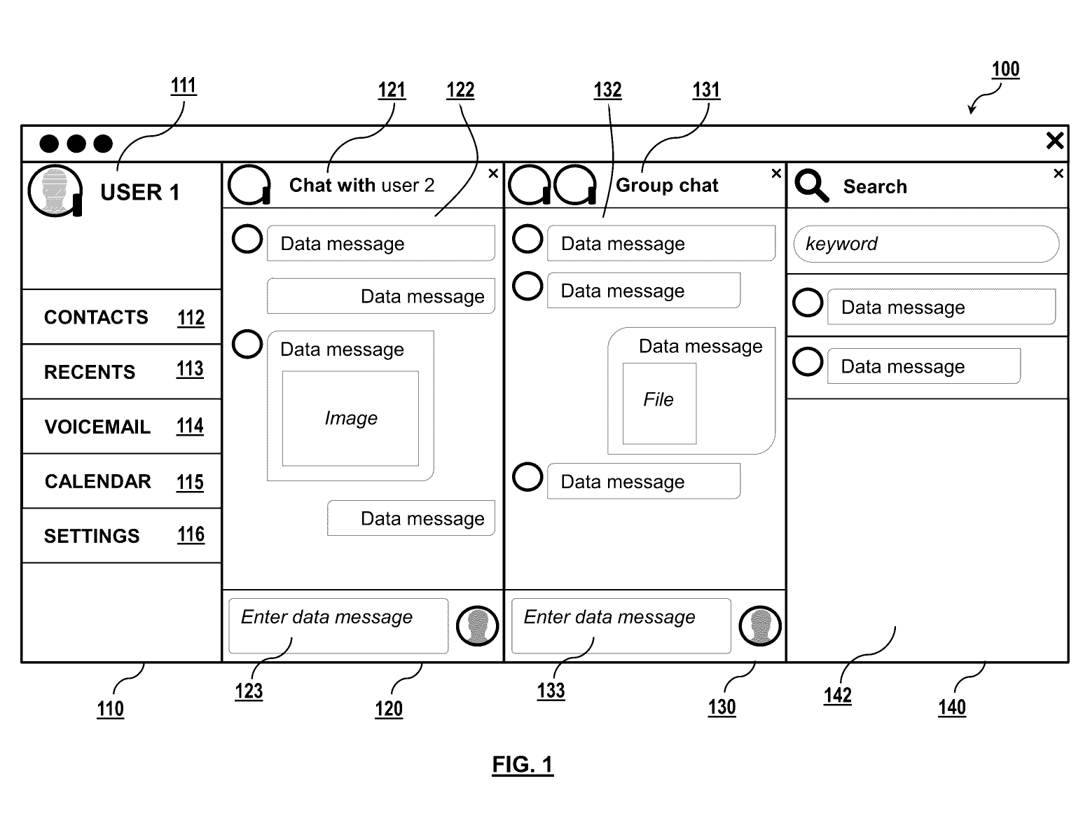

Reference is now made to FIG. 1, which is a simplified pictorial illustration of a user interface constructed and operative in accordance with an embodiment of the present invention. The user interface shown in FIG. 1 corresponds to an application user interface, typically for an instant messaging (IM) application such as, for example, but not limited to, Cisco Jabber, the user interface being displayed on a display screen of a computing device. The user interface is represented as an IM user interface window 100 comprising a plurality of bands arranged adjacently to each other such as, for example, but not limited to, a plurality of rows or columns arranged side-by-side. For simplicity of description and clarity, the term “column” is used hereinafter although it will be apparent to those skilled in the art that the terms “column”, “row”, or “band” may be used interchangeably.

In FIG. 1, the IM user interface window 100 may comprise, by way of non-limiting example, four different columns. Column 110 comprises a plurality of tabs enabling a user of the computing device to configure, manage and access different functionalities of the IM application. For the sake of simplicity of depiction, only six tabs 111 to 116 are shown in column 110 of FIG. 1. However, it will be appreciated by those skilled in the art that the number and the type of tabs are typically configurable. As shown in FIG. 1, column 110 may comprise for example, to the following non-limiting list of tabs:
tab 111 including information associated with the user of the computing device and/or with the user who entered his login and password when accessing the IM application. This information may include a picture and/or an avatar, a name, nickname, etc. and a current status for the user. The current status is configurable and may be set to, by way of non-limiting example, ‘Available’, ‘Busy’, ‘Do not disturb’, In presentation′, etc.;
tab 112 enabling the user to access to a list of contacts or a directory;
tab 113 enabling the user to view recent communications;
tab 114 enabling the user to access his voicemail;
tab 115 enabling the user to view the past, present and next meetings and/or access his calendar; and
tab 116 enabling the user to manage and configure the settings of the IM application.

Column 120 of the user interface represents a chat conversation between the user of the computing device and a remote user, indicated in FIG. 1, by way of example, as “user 2”. As shown in FIG. 1, column 120 comprises: a column header 121 typically comprising a title and/or any other appropriate information identifying the remote user and/or the type of conversation; a display area 122 including visual elements representing the on-going conversation (e.g. the data messages exchanged) between the computing device user and the remote user; and a message input area 123 enabling the computing device user to send data message to the remote user. The display area 122 is updated whenever a new data message is received from the remote user and/or sent by the computing device user. The data messages may comprise different types of data messages such as for example, but not limited to, text messages, pictures, files, audio and/or video message, etc.

Column 130 of the user interface of FIG. 1 is similar to column 120 but represents a chat conversation between the user of the computing device and a group of remote users. Similarly to column 120, column 130 comprises a header 131, a display area 132 and a message input area 133.

Lastly, a further column, column 140, is shown in FIG. 1. Column 140 is a column enabling the user of the computing device to search and filter data messages corresponding to one or more specified keywords. Data messages, for example the ones shown in display areas 122 and/or 132, which include one or more specified keywords, may be identified and displayed in display area 142 of column 140 as search results.

Those skilled in the art will appreciate that the present invention, in embodiments thereof, is not limited to the columns shown in FIG. 1. On the contrary, different types of columns may be provided as well as different functionalities enabling the user of the computing device to communicate with one or more remote users. For example, instead of having a column for filtering the data messages by keywords, column 140 may include, by way of non-limiting example, RSS feeds, clipboard items to use as canned responses, lists of meetings, recent active contacts, chat rooms, devices in close proximity of the computing device available to receive/transmit content, etc. Also, alternatively and/or in addition to displaying data messages in display areas 122 and 132 (i.e. chat conversations), columns 120 and 130 may enable the user of the computing device to launch an audio and/or video call, start share screen sessions, etc.

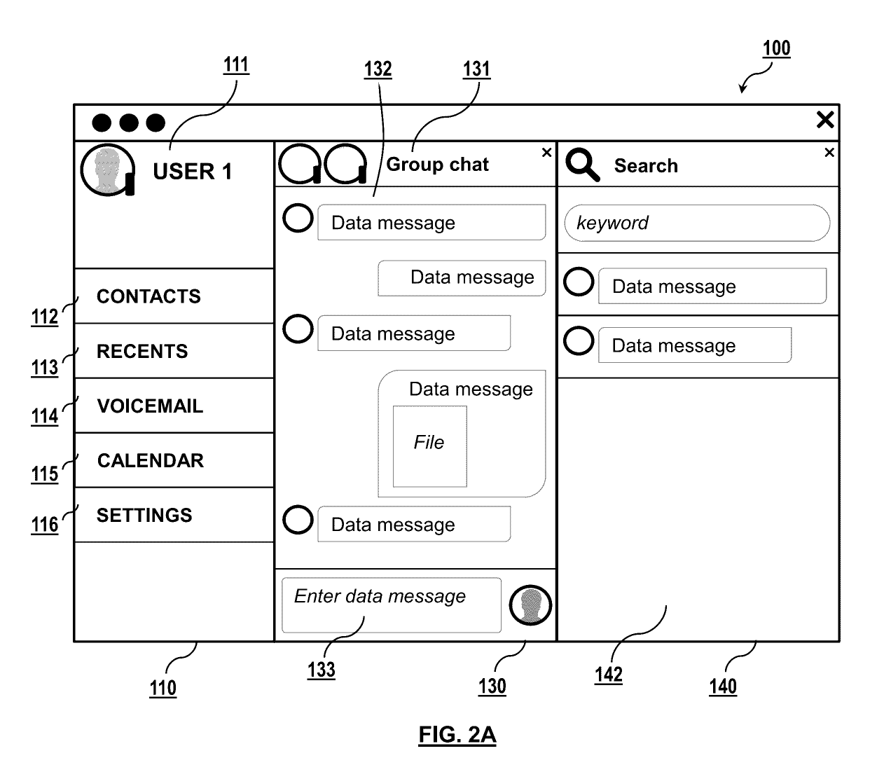

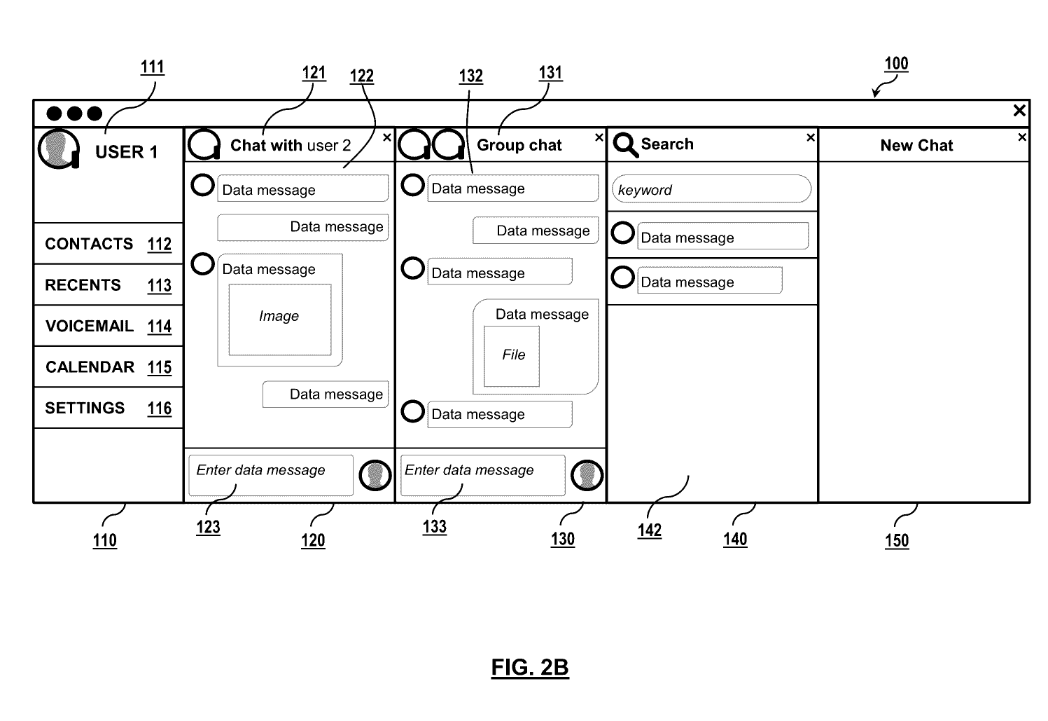

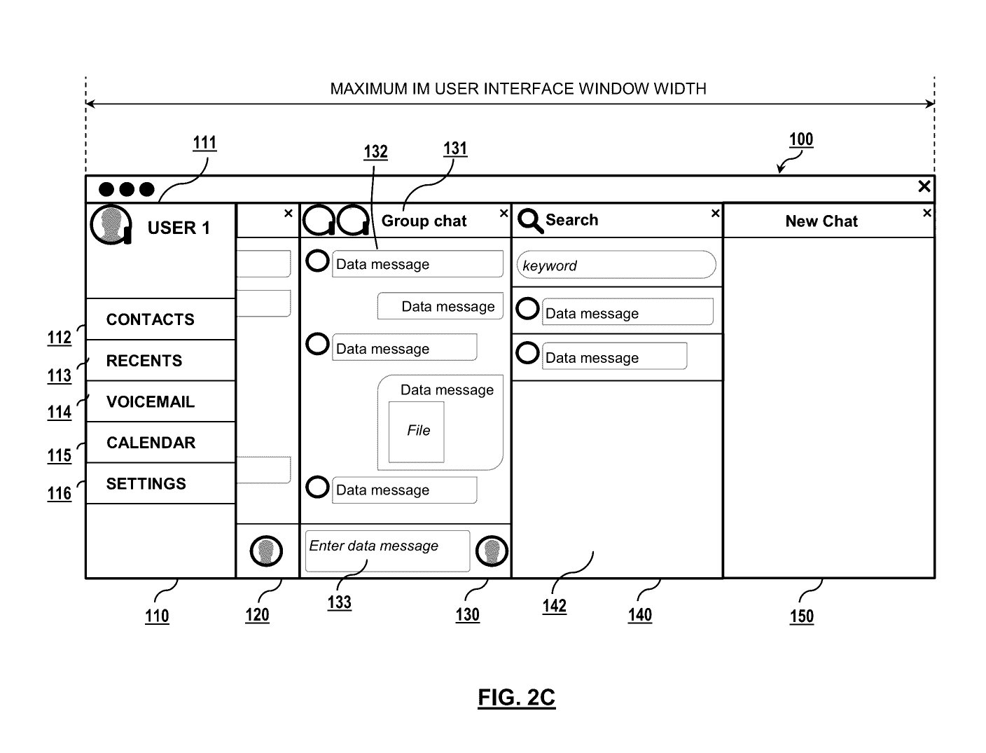

Reference is now made to FIGS. 2A, 2B and 2C which are simplified pictorial illustrations of user interfaces constructed and operative in accordance with embodiments of the present invention. The user of the computing device may decide to start and/or end a communication with one or more remote users (e.g. a chat conversation, an audio and/or video call, etc.) at any time. As a result, the IM user interface is updated to reflect the corresponding change(s).

FIG. 2A illustrates the situation, relative to the situation in FIG. 1, in which the user of the computing device decides to end a communication. In this case, the IM user interface is rearranged so that the corresponding column (e.g. column 120 of FIG. 1) is removed and column 130 is placed next to column 110. Furthermore, the IM user interface window 100 is resized to fit the new columns arrangement.

FIG. 2B illustrates the situation, relative to the situation in FIG. 1, in which the user of the computing device decides to start a new communication. In such a case, a new column (e.g. column 150) is added to the IM user interface. The IM user interface is therefore rearranged to add the new column 150 and the IM user interface window 100 is resized accordingly. Typically but not necessarily, the new column 150 is added to the right of the last column (i.e. column 140) of the IM user interface.

However, in another example embodiment of the present invention, display rules may be defined and applied at the time when the IM user interface is to be rearranged. The display rules specify how to display the IM user interface and/or how to rearrange the columns within the IM user interface. A display rule may specify that the new column is to be added at any suitable location within the IM user interface window 100. For example, instead of adding the new column 150 to the right of the last column (i.e. to the right of column 140 in FIG. 2B), the display rule may specify that the new column 150 is to be placed to the left of column 110 or immediately to the right of column 110.

Another display rule may specify that columns of the same type are to be grouped together i.e. placing the columns having the same type next to each other. Therefore, when the new column 150 to be added represents a chat conversation, it may be placed immediately to the right or to left of a column representing another chat conversation (e.g. to the right or to the left of column 130 in FIG. 2B).

In another example, when the new column 150 to be added represents a chat conversation between the computing device user and a single remote user, it may be placed immediately after the last column representing another chat conversation between the computing device user and another single remote user (e.g. immediately after column 120 in FIG. 2B).

A further display rule may specify an order for arranging the columns. For example, a particular order may specify placing: columns representing chat conversations between the computing device user and a single remote user immediately next to column 110; columns representing chat conversations between the computing device user and a group of remote users after the columns representing chat conversations between the computing device user and a single remote user; then, search and filtering columns; etc.

A further display rule may specify rearranging the columns based on the recent activity. For example, the columns may be rearranged so that the most recent active column is placed next to column 110; the second most recent active column is placed next to the most recent active column; etc. while the last column corresponds to the least recent active column. Whenever a new data message is received and/or transmitted by the IM application, the display area of the corresponding column is updated to reflect the change. At this time, the columns of the IM user interface may be rearranged so that the corresponding column is placed next to column 110 for instance. Those skilled in the art will realize that other display rules may be defined and applied to the IM user interface.

Alternatively and/or additionally, a maximum width may be provided for the IM user interface window 100. This maximum width typically corresponds to a maximum width available to display the IM user interface window 100, which width may be set, by way of non-limiting example, approximately to and/or to the width of the display screen of the computing device. When a new column is to be added to the IM user interface, the processor of the computing device is therefore able to check whether or not the overall width of the plurality of columns (including the width of the column to be added) exceeds the maximum width. If the overall width is less than the maximum width, the new column is added and the IM user interface window 100 is adjusted accordingly. However, if the overall width exceeds the maximum width, the IM user interface window 100 width is set to its maximum width and the columns are rearranged.

Rearranging the columns may comprise reducing the width of some or each column equally or even unequally, so that the overall width does not exceed the maximum width. Also, the visual elements of the different columns are updated/rearranged according to their reduced widths. A minimum column width may also be provided so that the columns may not be reduced when this minimum column width is reached. In a situation where the columns are reduced to their minimum widths and the overall width still exceeds the maximum width for the IM user interface window 100, one or more columns may be entirely and/or partially hidden.

FIG. 2C shows the IM user interface window 100 set to its maximum width and comprising a plurality of columns. The columns are the same as the ones shown in FIG. 2B with column 150 being the newly added column. As a result of inserting column 150 within the IM user interface window 100, column 120 is now partially hidden. In this configuration, the user of the computing device is still able to view and/or display column 120 by scrolling to the left. Since the IM user interface window 100 is set to its maximum width, such a scrolling operation may result in having column 120 displayed entirely while column 150, located on the opposite end of the IM user interface window 100, is being partially hidden.

In another example embodiment of the present invention, the user of the computing device is able to override the display rules. Overriding the display rules may comprise, by way of non-limiting example: defining pinned columns that will be displayed at the same location at any time; or defining pinned columns that will be displayed entirely at any time; rearranging the columns of the IM user interface window 100 “manually” (i.e. using any suitable device and/or method for interacting with the IM user interface) by dragging one or more of the columns to another location; etc.

Typical implementations of the computing device comprise at least one processor, one of which may be a special purpose processor operative to perform the methods for displaying the IM user interface, according to the methods described herein. In addition, the computing device comprises non-transitory processor-readable storage media (e.g. memory). The memory may store instructions, which at least one of the processors may execute, in order to perform the methods described herein. The computing device further comprises standard hardware and software components as are known in the art not specifically described herein, for the sake of brevity.

It is also appreciated that although the present specification describes a computing device, the methods and systems described herein may be implemented in any appropriate device which is a communication device. Such devices might include, by way of non-limiting example, a tablet device, a smartphone, a desktop or portable computer, a set-top box, an Internet-enabled television, a media center PC, or any other suitable device, such as are known in the art. Similarly, any appropriate pointing methods as are known in the art (e.g., but not limited to: mice, eye tracking methods, etc.) as well as direct manipulation by the computing user's finger on a touch screen associated with the computing device may be used to input signals via the IM user interface.

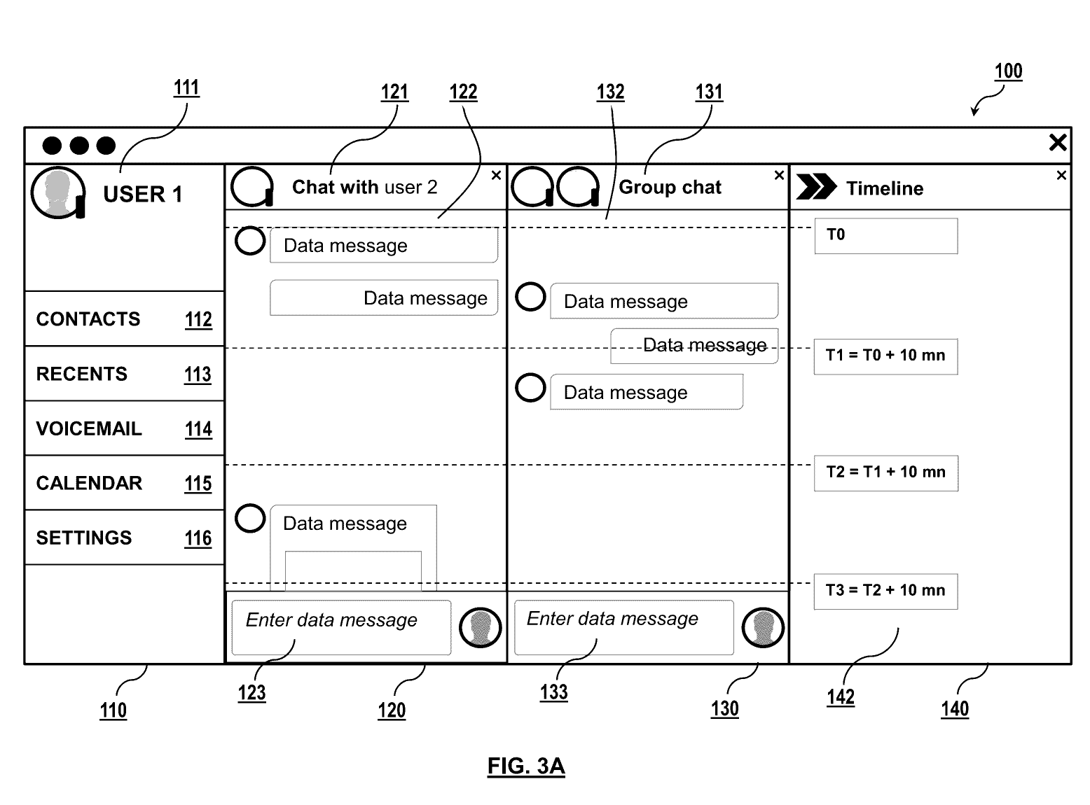

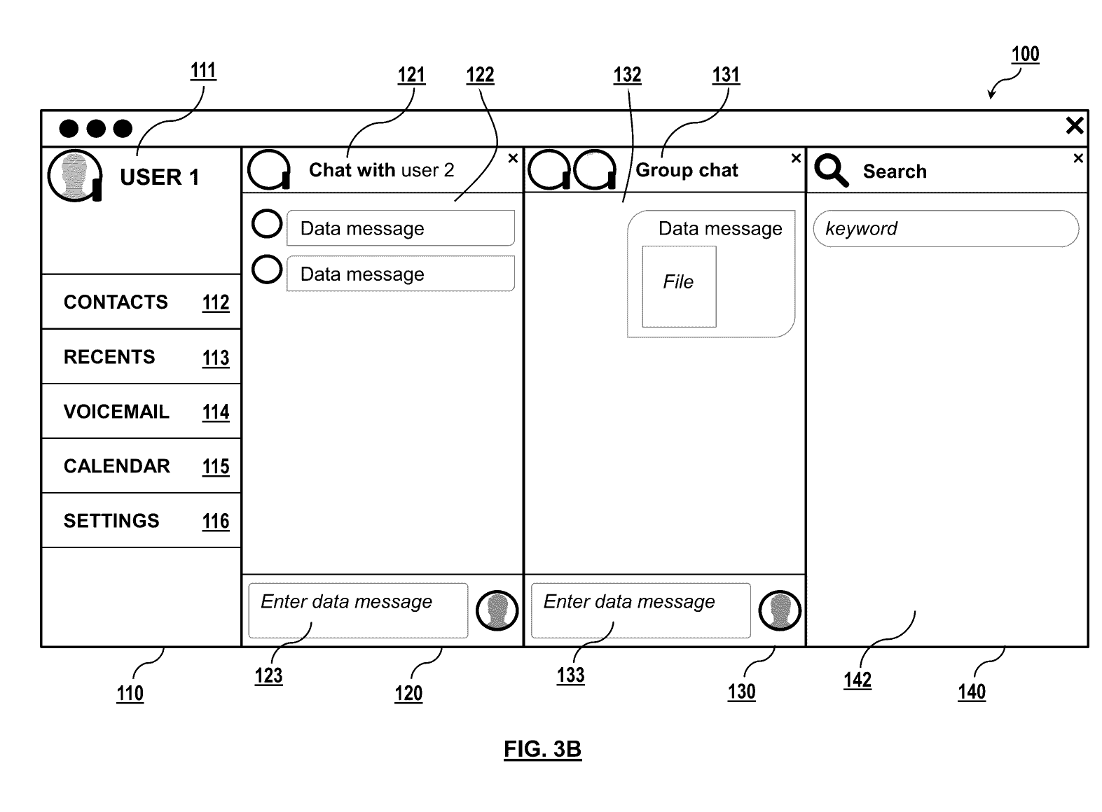

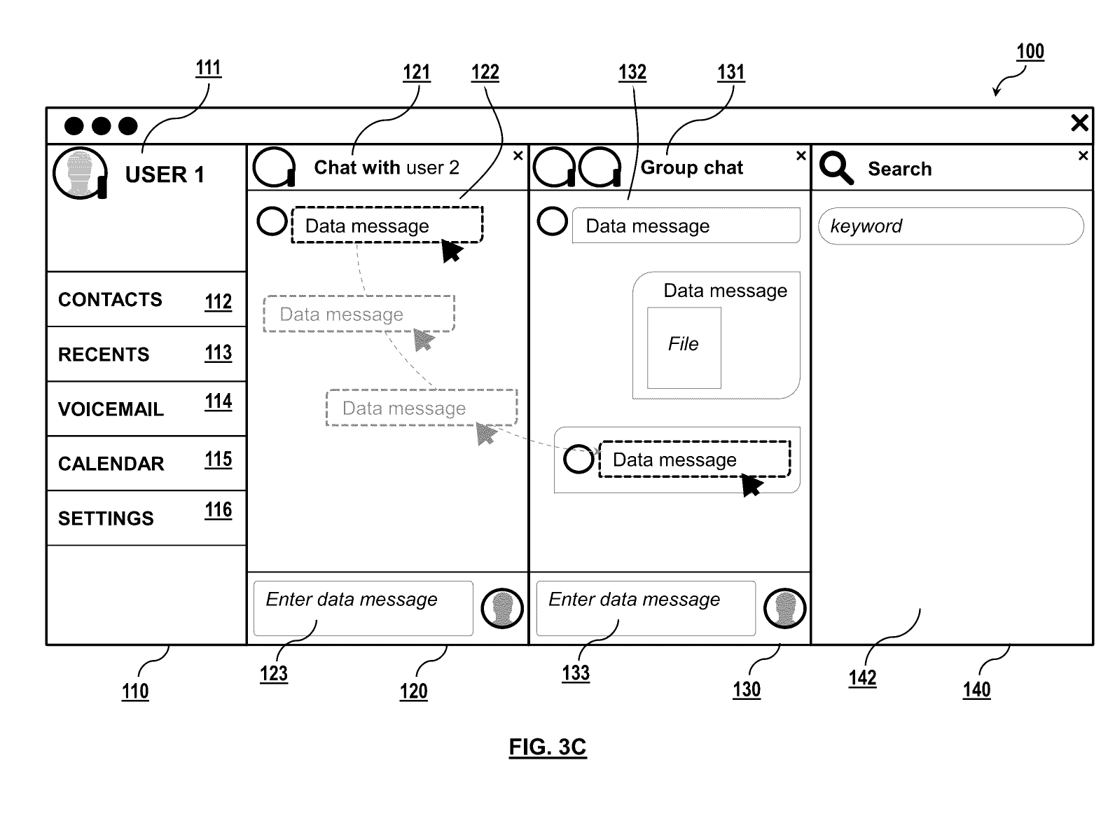

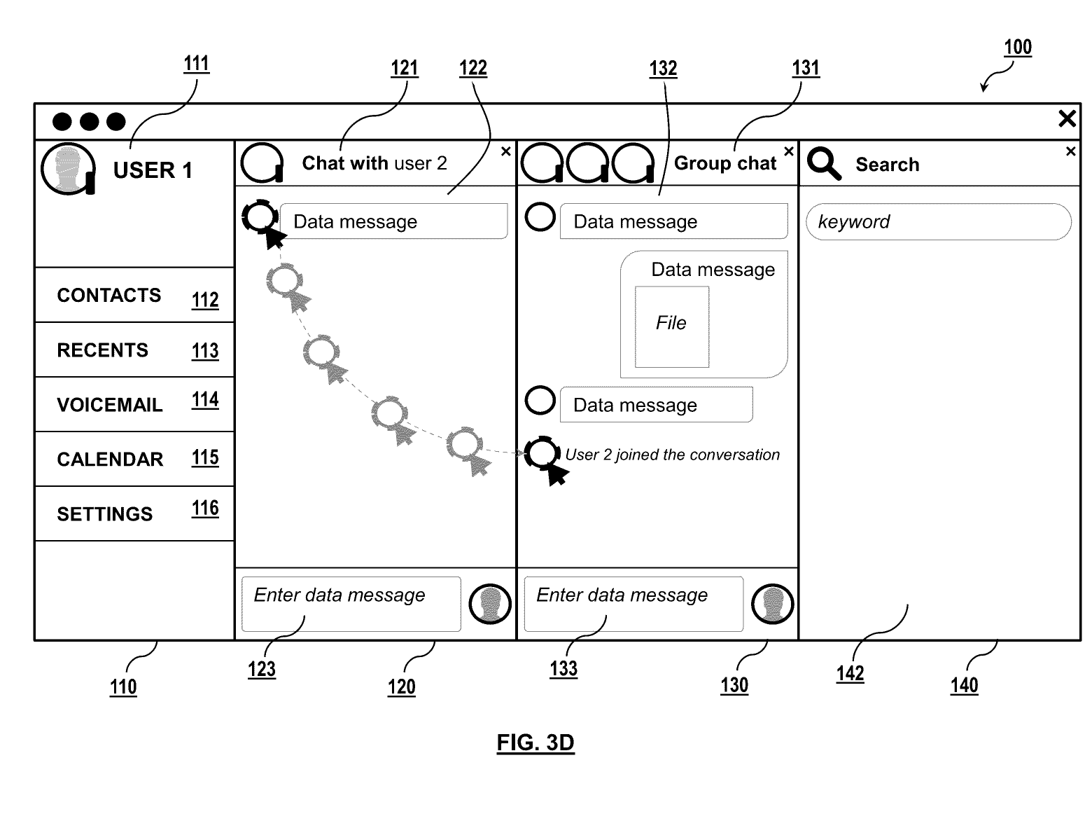

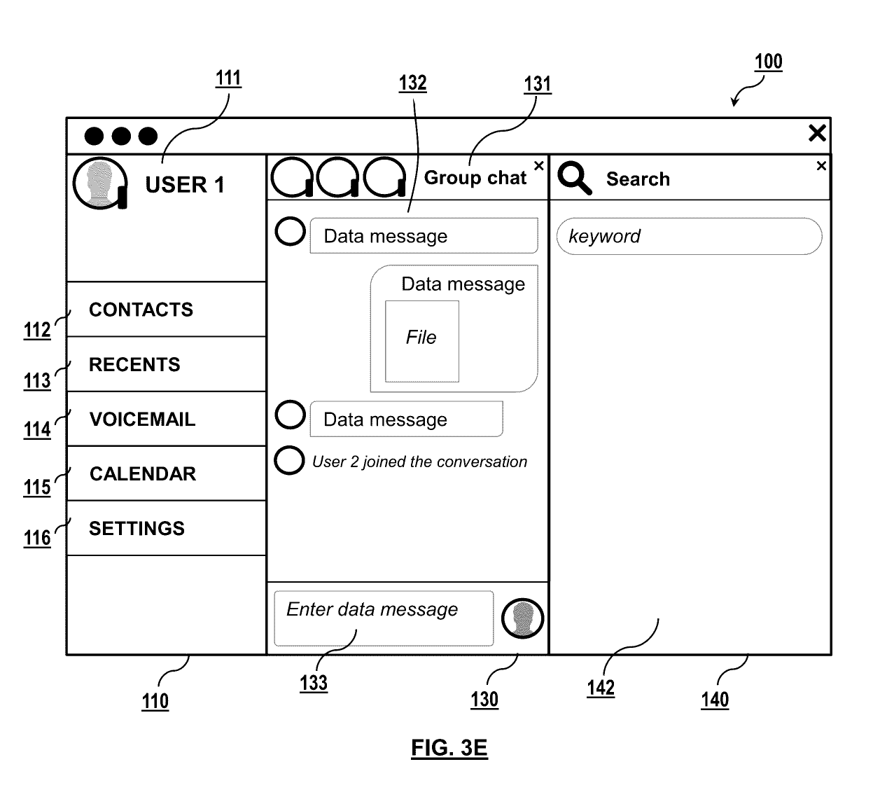

Reference is now made to FIGS. 3A, 3B, 3C, 3D and 3E which are simplified pictorial illustrations showing interactions between columns of a user interface constructed and operative in accordance with further embodiments of the present invention.

FIG. 3A shows the IM user interface window 100 of FIG. 1 in which the display of the visual elements in display area 122 of column 120 and display area 132 of column 130 has been updated/rearranged so that the visual elements are sorted by time. Typically, the user of the computing device interacts with column 140 of the IM user interface to activate the ‘timeline’ feature. In FIG. 3A, the search column 140 of FIG. 1 is replaced by another type of column enabling the computing device user to activate the timeline feature. As a result of activating the timeline feature, the visual elements in displays areas 122 and 132 are sorted by time and timing information may be displayed in the display area 142 of column 140. The timeline feature is associated with a particular unit of time which is used to sort the visual elements in display areas 122 and 132. Although the unit of time is set to ten minutes in FIG. 3A (as it is apparent from display area 142), those skilled in the art will appreciate that the unit of time is typically freely configurable and may be set to any other suitable unit of time. In any case, a processor of the computing device is configured to use the unit of time for generating the updated display of display areas 122 and 132.

As explained hereinabove in relation to FIG. 1, display area 122 comprises visual elements representing a communication between the user of the computing device and one remote user. Each visual element may comprise sub-elements such, by way of non-limiting example, an identifier of the sender (e.g. an avatar, a picture, or any other appropriate identifier), a data message (e.g. text, pictures, documents, etc.) and some additional information (e.g. a date, a time at which the data message is received or displayed by the IM user interface, etc.). The visual elements are displayed in display area 122 in a conventional manner, that is to say, one after another as they are received from the sender.

FIG. 3A shows the same column after activation of the timeline feature. The processor generates a new display for display area 122 in which the visual elements are rearranged according to the unit of time. The same process is performed for display area 132 of FIG. 1 (representing a chat conversation between the computing device and a group of remote users) and the result shown in FIG. 3A. It will be apparent that in some situations (i.e. depending on the chosen unit of time), only a subset of the visual elements may be displayed in the newly generated display areas.

The same process may also be applied to other type of columns such as for example a column whose visual elements represent a list of meetings of the computing device user. In this situation, the visual elements of the corresponding display area may be arranged according to the unit of time so that only a subset of the meetings is shown in the newly generated display area. In any case, the user of computing may be able to view all the content (e.g. data messages, meetings, etc.) by scrolling up and/or down within the relevant column.

FIG. 3B shows the IM user interface window 100 of FIG. 1 in which the display of the visual elements in display area 122 of column 120 and display area 132 of column 130 has been updated/rearranged so that the visual elements are sorted by keywords. Typically, the user of the computing device interacts with column 140 of the IM user interface to enter a keyword. As a result of typing a keyword, the visual elements in displays areas 122 and 132 are sorted and only the visual elements containing the typed keyword are shown. Additionally and/or alternatively, instead of entering keyword(s), the user of the computing device is able to specify any other suitable attribute to perform a similar sorting operation. By way of non-limiting example, a type of content and/or data message (e.g. picture, slide, audio and/or video, file, etc.) or a user identifier (e.g. avatar, name, etc.) may be selected as the attribute to be used for sorting the visual elements of display areas 122 and 132. As a result the visual elements in displays areas 122 and 132 are sorted and only the visual elements relevant to the attributes are shown. Lastly, the user of the computing device may also be able to combine the different attributes (e.g. keywords, types of data messages, identifiers, etc.) to perform different sorting operations.

FIG. 3C shows another exemplary interaction between columns of the IM user interface. FIG. 3C shows the IM user interface window 100 of FIG. 1 (with some visual elements removed for sake of simplicity of depiction) in which a data message displayed in display area 122 of column 120 is selected by the computing device user to be added to display area 132 of column 130. Typically, the computing device user first selects the data message (e.g. text, image, slide, etc.) from display area 122 using any suitable pointing method, and then drags and drops the data message into display area 132.

FIG. 3C shows two intermediate steps (in dark grey) illustrating the path followed during the drag and drop operation. As a result of the drag and drop operation, the visual elements of display area 132 are updated/rearranged to include the newly added data message. For example, the data message from display area 122 may be added to display area 132 after the last displayed message. In such a situation, other sub-elements (e.g. identifier and additional information) associated with the data message may also be displayed in display area 132, thereby maintaining integrity and authorship of the original data message. In a situation where column 130 represents, for example, an audio and/or video call, the drag and drop operation may result in updating the display area 132 so that the data message is viewed during a screen share session. Although FIG. 3C shows a drag and drop operation for a single data message, it is apparent that the user of the computing device may be able to select multiple data messages at the same time and to drop the selected multiple data messages into a relevant display area. Such functionality enables the computing device user to share content easily and intuitively with one or more remote users.

FIG. 3D shows a further exemplary interaction between columns of the IM user interface. FIG. 3D shows the IM user interface window 100 of FIG. 1 (with some visual elements removed for sake of simplicity of depiction) in which an identifier of a remote user (e.g. avatar, picture, etc.) displayed in display area 122 of column 120 is selected by the computing device user to be added to display area 132 of column 130. Typically, the computing device user selects the identifier from display area 122, and then drags and drops the identifier into display area 132.

FIG. 3D shows a plurality of intermediate steps (in dark grey) illustrating the path followed during the drag and drop operation. As a result of such an operation, the visual elements of display area 132 are updated/rearranged to include the remote user newly added to the chat conversation. For example, the identifier from display area 122 may be added to display area 132 after the last displayed message to inform the group of remote users that a new remote user has been invited to and/or has joined the conversation. Also, the identifier of the new remote user may be added to the column header 131. Although FIG. 3D shows a drag and drop operation for a single identifier, it is apparent that the user of the computing device may be able to select multiple identifiers at the same time and drop them into a relevant display area. Similarly, although FIG. 3D shows adding the remote user of column 120 to the chat conversation represented by column 130, the computing device may be able to select the identifier from column 140 in a situation where column 140 currently displays the recent active contacts, for example. Such functionality enables the computing device user to add and/or invite remote users to a chat conversation easily and intuitively.

FIG. 3E shows the result of another exemplary interaction between columns of the IM user interface. FIG. 3E shows the IM user interface window 100 of FIG. 1 after selecting, dragging and dropping the column header 121 of column 120 into display area 132 of column 130. Typically, the computing device user drags and drops the column header 121 into display area 132 in a similar manner as in FIGS. 3C and 3D. As a result of such an operation, the two communications (e.g. chat conversations) are merged into a single communication and the IM user interface is rearranged. The IM user interface may be rearranged so that column 120 is removed, column 130 is placed next to column 110 and the IM user interface window 100 is resized to fit the new columns arrangement. In such a case, the visual elements of display area 132 may still be displayed so that the newly added remote user is able to read and catch-up with the on-going conversation. Also, the visual elements of display area 132 may be updated/rearranged to include the remote user from column 120 newly added to the chat conversation. For example, the identifier from display area 122 may be added to display area 132 after the last displayed message to inform the group of remote users that a new remote user has been invited to and/or joined the conversation. Also, the identifier of the new remote user may be added to the column header 131.

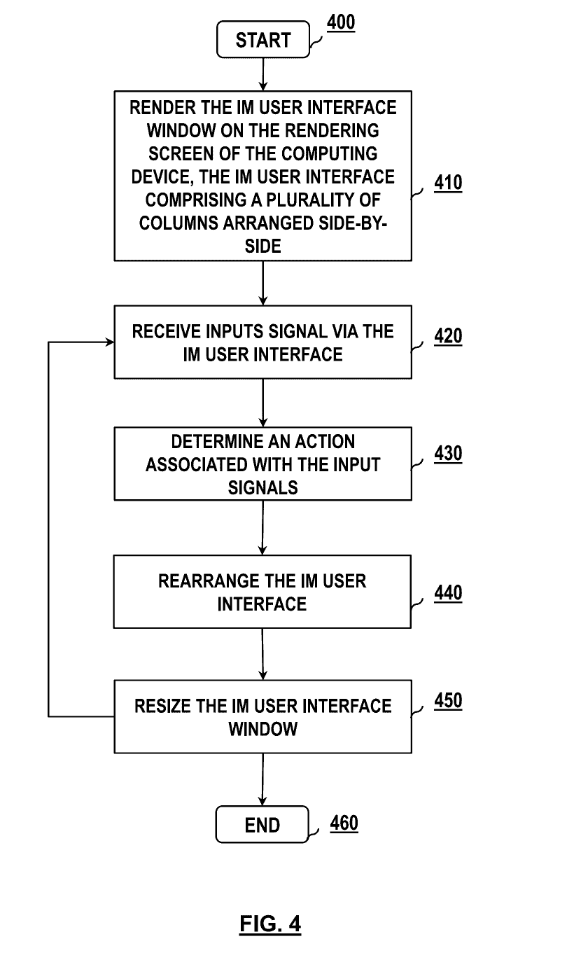

Reference is now made to FIG. 4, which is a simplified flow chart diagram illustrating a method for operating the user interface in accordance with embodiments of the present invention.

The process starts at step 400. Typically, a user is able to start/launch the IM application on a computing device. Once access to the IM application is granted, for example, after the user has successfully entered his login/password, the user may decide to start one or more chat conversations, audio and/or video calls, share screen sessions, etc. with one or more remote users.

At step 410, the processor of the computing device generates and renders the IM user interface window 100 on the display screen of the computing device. For example, the user may have started a first chat conversation with a remote user, a second chat conversation with two remote users and performed a keyword search. Such a configuration is depicted in FIG. 1 which shows: a first column corresponding to the chat conversation between user 1 (computing device user) and user 2 (remote user); a second column corresponding to the group chat conversation between user 1 and a group of remote users; and a third column corresponding to the keyword search. In any case, the IM user interface is rendered in a single IM user interface window which comprises a plurality of columns arranged side-by-side.

At step 420, the processor of the computing device receives input signals from the computing device user. Typically, the computing device user interacts with one or more of the plurality of columns of the IM user interface, rendered on a display screen of the computing device, using any appropriate pointing methods as are known in the art (e.g., but not limited to: mice, eye tracking methods, etc.) or by direct manipulation by the computing user's finger on a touch screen associated with the computing device.

Then, the processor determines at step 430 the action associated with the input signals received from the computing device user. The input signals received by the processor may correspond to different actions such as, for example, but not limited to: starting/ending a chat conversation; starting/ending an audio and/or video call; starting/ending a share screen session; filtering the columns currently being displayed by keywords, contacts, times etc.; dragging and dropping one or more data messages from a first column to a second column; dragging and dropping an identifier from a first column to a second column; etc. Once the processor has determined the action associated with the input signals, the process continues at step 440.

At step 440, the processor of the computing device rearranges the columns of the IM user interface according to the action determined in the previous step (step 430). Rearranging the columns of the IM user interface may comprise, by way of non-limiting example, adding a new column, removing a column, merging two or more columns, sorting the columns, etc. The processor may also use the display rules described hereinabove for rearranging the columns of the IM user interface. Also, rearranging the columns may comprise rearranging the visual elements displayed in the different display areas of the columns. For example, in a situation where the input signals corresponds to a data message or identifier drag and drop operation(s), the processor is able to rearrange the visual elements in the corresponding column display area. Rearranging the columns may also comprise reducing the width of the columns so that a maximum width for the IM user interface window 100 is not exceeded. Lastly, in a situation where the columns have been reduced to their minimum widths but the overall width still exceeds the maximum width for the IM user interface window 100, rearranging the columns may comprise hiding partially and/or entirely one or more of the columns.

At step 450, the processor is further able to resize the IM user interface window 100 according to the new columns arrangement obtained from step 440. The process may start again from step 420 if new input signals are received or ends at step 460 if the computing device user decides to close the IM application.

It is appreciated that software components of the present invention may, if desired, be implemented in ROM (read only memory) form. the software components may, generally, be implemented in hardware, if desired, using conventional techniques. It is further appreciated that the software components may be instantiated, for example: as a computer program product on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method implemented on a computing device, said method comprising:
rendering a user interface on a display screen of said computing device, said user interface comprising a plurality of bands arranged adjacently to each other in a single user interface window, wherein at least one of said plurality of bands represents a communication between a user of said computing device and one or more remote users;
receiving input signals from a user of said computing device, said input signals corresponding to a user interacting with one of said plurality of bands of said user interface; and
in response to said received input signals,
rearranging said plurality of bands; and
resizing said single user interface window to fit said rearranged plurality of bands.

2. The method of claim 1, wherein said plurality of bands comprises one of: a plurality of columns; or a plurality of rows.

3. The method of claim 1, wherein said rearranging comprises adding at least one new band to said plurality of columns and/or removing at least one band from said plurality of bands.

4. The method of claim 1, wherein said rearranging comprises sorting said plurality of bands according to at least one display rule, said at least one display rule specifying how to rearrange said plurality of bands.

5. The method of claim 4, wherein said at least one display rule specifies a particular location at which to insert said new band.

6. The method of claim 4, wherein said at least one display rule specifies placing bands of a same type next to each other.

7. The method of claim 4, wherein said at least one display rule specifies sorting said plurality of bands from a most to a least recently active band.

8. The method of claim 1, wherein said rearranging comprises reducing a width of some or each of said plurality of bands so that a maximum width for said user interface window is not exceeded.

9. The method of claim 8, wherein said maximum width for said user interface window corresponds to the width of said display screen of said computing device.

10. The method of claim 8, wherein said rearranging further comprises partially and/or completely hiding one or more of said plurality of bands so that a maximum width for said user interface window is not exceeded.

11. The method of claim 1, wherein said rearranging said plurality of bands comprises rearranging visual elements displayed in a display area of said at least one of said plurality of bands, said at least one of said plurality of bands representing a communication between a user of said computing device and one or more remote users.

12. The method of claim 11, wherein said rearranging comprises rearranging said visual elements according to a particular timescale in response to said received input signals, said received input signals corresponding to a user activating a timeline feature via interaction with a band of said plurality of bands other than said band representing a communication between a user of said computing device and one or more remote users.

13. The method of claim 11, wherein said rearranging comprises sorting said visual elements to display only the ones comprising a particular keyword in response to said received input signals, said received input signals corresponding to a user specifying said particular keyword via interaction with a band of said plurality of bands other than said band representing a communication between a user of said computing device and one or more remote users.

14. The method of claim 11, wherein said rearranging comprises sorting said visual elements to display only the ones corresponding to a particular type of content in response to said received input signals, said received input signals corresponding to a user specifying said particular type of content via interaction with a band of said plurality of bands other than said band representing a communication between a user of said computing device and one or more remote users.

15. The method of claim 11, wherein said rearranging comprises updating said display area to add a visual element in response to said received input signals, said received input signals corresponding to a user: dragging a data message from a band of said plurality of bands other than said at least one of said plurality of bands representing a communication between a user of said computing device and one or more remote users; and dropping said data message into said display area of said at least one of said plurality of bands representing a communication between a user of said computing device and one or more remote users.

16. The method of claim 11, wherein said rearranging comprises updating said display area to add a visual element in response to said received input signals, said received input signals corresponding to a user: dragging an identifier from a band of said plurality of bands other than said at least one of said plurality of bands representing a communication between a user of said computing device and one or more remote users; and dropping said identifier into said display area of said at least one of said plurality of bands representing a communication between a user of said computing device and one or more remote users.

17. The method of claim 1, wherein said rearranging comprises merging two bands in response to said received input signals, said input signals corresponding to a user: dragging a header of a first band representing a first communication between a user of said computing device and one or more first remote users; and dropping said header into a display area of a second band representing a second communication between a user of said computing device and one or more second remote users.

18. The method of claim 17, wherein said rearranging comprises updating said display area of said second band to add a visual element indicating that said one or more remote users of said first communication joined said second communication.

19. A user interface comprising:
a display screen of a computing device operative to render a plurality of bands arranged adjacently to each other in a single user interface window, wherein at least one of said plurality of bands represents a communication between a user of said computing device and one or more remote users; and
a processor operable to receive input signals from a user of said computing device, said input signals corresponding to a user interacting with one of said plurality of bands, said processor being further operable, in response to said received input signals, to rearrange said plurality of bands and resize said single user interface window to fit said rearranged plurality of bands.

20. A system comprising:
a user interface for a computing device, said user interface comprising a plurality of bands arranged adjacently to each other in a single user interface window, wherein at least one of said plurality of bands represents a communication between a user of said computing device and one or more remote users;
a processor operable to receive input signals from a user of said computing device, said input signals corresponding to a user interacting with one of said plurality of bands of said user interface; and
in response to said received input signals, said processor is further operable to rearrange said plurality of bands; and resize said single user interface window to fit said rearranged plurality of bands.
